(19) United States
(12) Patent Application Publication
(10) Pub. No.: US 2005/0237394 A1
(43) Pub. Date: Oct. 27, 2005

(54) Flicker detection for image sensing devices

(76) Inventors: Behnam Katiblan, Irvine, CA (US); Ananthapadmanabhan Arasanlpalai Kandhadai, San Diego, CA (US)

Correspondence Address: Qualcomm Incorporated;Patents Department, 5775 Morehouse Drive, San Diego, CA, 92121-1714, US

(21) Appl. No.: 11/108,919

(22) Filed: Apr. 18, 2005

Related U.S. Application Data
(60) Provisional application No. 60/564,668, filed on Apr. 21, 2004.

(51) Int. Cl. H04N 9/73

(52) U.S. Cl. 348/226.1

(57) ABSTRACT

Camera systems are presented that can utilize geographical information to detect and avoid flicker conditions caused by fluorescent lighting automatically. The camera systems are configured to work in conjunction with signals from wireless communication networks or the GPS system.

### CROSS-REFERENCE TO RELATED APPLICATIONS

This application claims priority to U.S. Provisional Application No. 60/564,668, filed on Apr. 21, 2004, the entire content of which is incorporated herein by reference.

### BACKGROUND

1. Field

The present invention is directed towards image processing, and in particular, to image sensing.

2. Background

In many camera systems, image sensing is performed using an electronic “rolling shutter,” which is an exposure mechanism that exposes pixels within an image sensor array, typically on a line by line basis. The duration of the exposure may be programmable, so that the exposure may range from a partial line duration, a single line duration, or any value up to and including a full image frame duration.

Due to the nature of the rolling shutter, the pixel lines of one image section may be exposed to different lighting conditions than the pixel lines of another image section since each section is exposed at a different time. Under daylight or incandescent lighting conditions, the lighting condition does not noticeably vary within the short duration of the exposure process so that the use of an electronic rolling shutter in the camera system does not noticeably affect the image. However, under fluorescent lighting conditions, a problem known as “flicker” arises.

The flicker problem is caused due to the sensitivity of the electronic shutter to variations in light intensity. Unfortunately, variations in light intensity occur under fluorescent lighting conditions.

Fluorescent lighting generally operates under the principle that an electric current stimulates atoms of an element, such as mercury, which in turn stimulates a phosphor, which in turn emits visible light photons. Alternating current (AC), the standard power supply format around the world, drives fluorescent lighting in a sinusoidal manner around a zero crossing, at which point there is no current. Since zero crossings occur twice in any given period, there is a corresponding diminishment of light intensity twice in any given period.

Since the AC supplies available in most countries have ether a 50 Hz or a 60 Hz cycling frequency, zero crossings occur every 1/100 second or 1/120 second, depending upon the geographical region. Whenever a zero crossing is captured by the shutter, a dark band appears in the image, which often renders the image undesirable to viewers.

Since this is a known quantity, most camera system manufacturers have avoided the flicker problem by limiting the integration times of the sensor to multiples of the period of the AC power:
Integrationsᵢ=n·(T_{f}/2),
wherein Integrations is the sensor exposure/integration time, T_{f} is the Period of the AC power supply frequency, and n is an integer value (normally between 1 and the maximum number of lines in the image sensor).

However, user intervention is required whenever a camera system is used in various geographical regions with differing AC power supplies. For example, if a camera is set for operation in United States, which has AC operating at 60 Hz, but the camera user travels to India, which has AC operating at 50 Hz, then the camera user must consciously remember to change the exposure setting of the camera to compensate for the different fluorescent lighting condition, or else suffer from poor quality images. No mechanism presently exists for allowing the camera system to detect and avoid the flicker problem without user intervention.

### SUMMARY

Methods and apparatus are presented herein to address the need described above. In particular, camera systems are presented that can utilize geographical information to detect and avoid flicker conditions without user intervention.

In one aspect, the geographical location of a camera system is determined through the detection of signals sent over wireless communication systems. For example, the Extended System Parameters Message sent on the Paging Channel of the cdma2000 wireless communication system has a field called Mobile Country Code (MCC). The wireless communication device (also referred to herein as “handset” or “mobile station”) stores the MCC and does not need to update it unless there is a change in the MCC value. A camera system that is communicatively coupled or incorporated into the device may use the MCC to set the appropriate flicker condition as the handset enters a country.

In another example, the geographical location of a camera system may be determined through position indicators, such as longitude and longitude, from a base station to the handset. Various processing and memory elements in the handset would be configured to match the position indicators to the appropriate country. This example may be implemented in any wireless communication system since the position indicator may be preprogrammed into each base station and sent over-the-air as either payload or control information.

In another example, the geographical location of a camera system may be determined through detecting a base station identifier. A camera system is incorporated into, or communicatively coupled to, a wireless communication device configured to operate in the same network as a base station. When the device determines the identity of a base station, the device may determine in what country the base station is located through the use of a lookup table. In a Code Division Multiple Access (CDMA)-based system, the identification of the base station is through an offset in the pseudorandom noise (PN) sequence.

In another aspect, the camera system is communicatively coupled to circuitry for detecting a Global Positioning System (GPS) signal. The GPS signal is used to determine the geographical location of the camera system. Once the geographical location is determined, the camera system may look up whether the geographical location is in a region with 50 Hz or 60 Hz power supplies.

### BRIEF DESCRIPTION OF THE DRAWINGS

FIG. 1 is a drawing of a sinusoidal AC wave.

FIG. 2 is a block diagram illustrating a camera system incorporated into a wireless communication device.

FIG. 3 is a flow chart illustrating a method for flicker detection and correction.

FIG. 4 is another flow chart illustrating a method for flicker detection and correction.

### DETAILED DESCRIPTION OF EMBODIMENTS

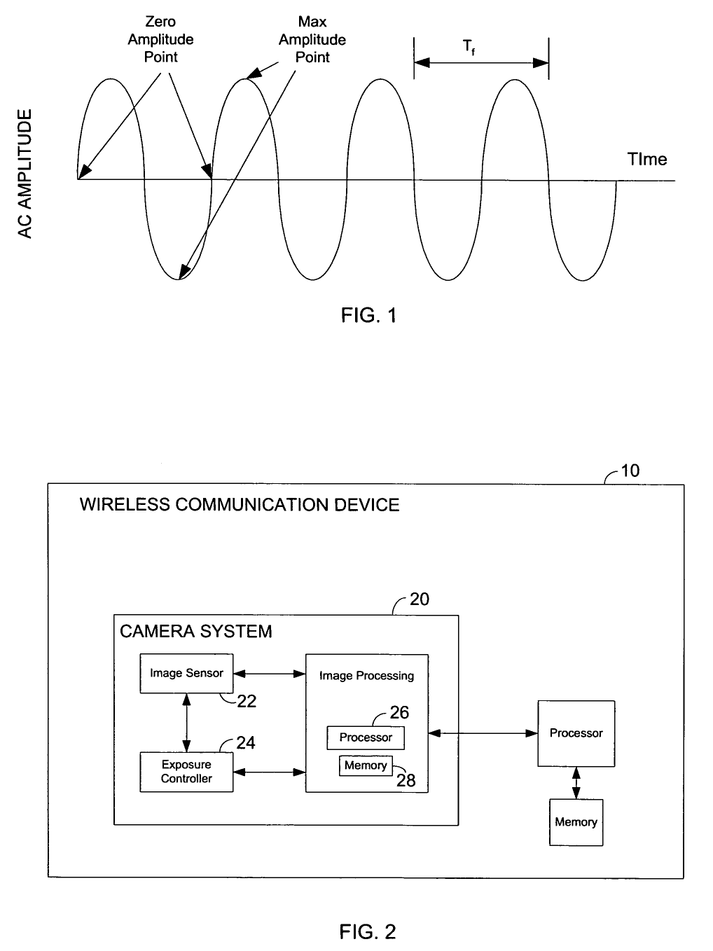

FIG. 1 is a representation of a sinusoidal AC wave with a period T_{f}. As discussed previously, zero crossings of the sinusoidal AC wave correspond to diminished light intensity in fluorescent lighting conditions, which negatively affects images detected by a sensor in a camera system. A solution exists for avoiding this “flicker” problem, whereby the rolling shutter is limited to exposure times that are multiples of the AC period. However, this solution is limited in that the solution requires manual user intervention whenever the camera system is transported between regions of different AC periods.

The embodiments that are described herein are for using certain technical features of a wireless communication device to automatically set the exposure times of the rolling shutter.

FIG. 2 is a block diagram of a camera system that is incorporated into a wireless communication device. The wireless communication device 10 may comprise a cellular telephone, personal digital assistant (PDA), or mobile computer. The camera system 20 may comprise an image sensing portion 22, an exposure control portion 24, and various microprocessor elements 26 and memory elements 28 for processing a detected image.

In one embodiment, the geographical location of a camera system is determined through the detection of signals sent over a wireless communication system to the wireless communication device. For example, the Extended System Parameters Message sent on the Paging Channel of the cdma2000 wireless communication system has a field called Mobile Country Code (MCC). The wireless communication device stores the MCC and does not need to update the MCC unless there is a change in the MCC value. A camera system that is communicatively coupled or incorporated into the device may use the MCC to set the appropriate flicker condition as the handset enters a country. Specifics for the MCC is provided in Section 2.6.2.2.5 of IS-2000, which is promulgated by the Telecommunications Industry Association (TIA).

Once the wireless communication device receives the MCC value, microprocessor and memory elements within the device determine the frequency at which the AC operates in that particular country. Once the AC frequency is known, this information is passed to the camera system and is used therein to set the exposure time of the exposure control portion. In another aspect, the MCC value is passed directly to the camera system and the camera system is configured to determine the geographical location and the AC operating frequency. Once the local AC operating frequency is known, the camera system sets the exposure time accordingly.

Variations of this embodiment may be implemented in non-cdma2000 systems by using any equivalent message types that carry country information. This embodiment, and the embodiments that follow, may be used to change the exposure time of the electronic rolling shutter whenever travel occurs between countries with different AC operating frequencies.

In another embodiment, the geographical location of a camera system may be determined through position indicators, such as longitude and longitude, sent from an infrastructure element to the handset. Various microprocessor and memory elements in the handset would be configured to match the position indicators to the appropriate country, using lookup tables for example. This embodiment may be implemented in any wireless communication system since the position indicator may be preprogrammed into each infrastructure element and sent over-the-air as either payload or control information. An infrastructure element may be any functional entity within the network architecture that is responsible for radio resource allocation to a wireless communication device.

This particular embodiment would be useful for those counties that have both 50 Hz and 60 Hz cycling frequencies, such as Japan, since the lookup tables may be tailored to cover regions of the countries, not just the country information itself.

In another embodiment, the geographical location of a camera system may be determined through the detection of an infrastructure identifier. A camera system is incorporated into, or communicatively coupled to, a wireless communication device configured to operate in the same network as an infrastructure element, such as, for example, a base station. When the device determines the identity of a base station, the device may determine in what country the base station is located through the use of a lookup table. In a Code Division Multiple Access (CDMA)-based system, the identification of the base station is through an offset in the pseudorandom noise (PN) sequence.

Again, this embodiment would be particularly useful for travel within those countries that have both 50 Hz and 60 Hz cycling frequencies since the lookup tables may be tailored to cover regions of the countries, not just the country information itself. This particular embodiment may also be performed by any non-CDMA system that has a mechanism for identifying base stations.

In yet another embodiment, the geographical location may be determined through a GPS signal. A camera system is communicatively coupled to circuitry for detecting a Global Positioning System (GPS) signal. The GPS signal is used to determine the geographical location of the camera system. Once the geographical location is determined, the camera system may look up whether the geographical location is in a region with 50 Hz or 60 Hz power supplies. Note that this embodiment may or may not utilize a wireless communication device since this embodiment is directed to GPS signals.

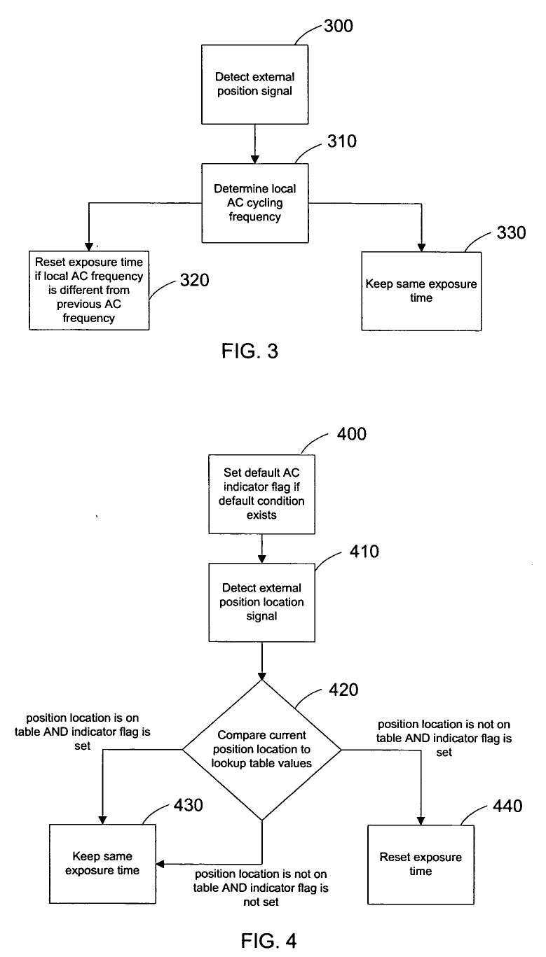

FIG. 3 is a flow chart illustrating the basic method steps for flicker detection and correction based on geographical information. At step 300, an external signal is detected and processed for the geographical location of the camera system. At step 310, the geographical location is compared to values in a lookup table in order to determine the cycling frequency of the local AC power supply. At step 320, the camera system resets the exposure time if the local AC power supply is different from the AC power supply of the previous geographical location. Alternatively, at step 330, if the local AC power supply is the same as the AC power supply of the previous geographical location, then the camera system refrains from altering the exposure time. Note that the exposure time may be determined using any of the various techniques that are currently available.

FIG. 4 is a flow chart illustrating a version of the method described in FIG. 3. At step 400, an indicator flag is set for a current exposure time corresponding to a default AC power supply. At step 410, an external signal is detected and processed for the current geographical location of the camera system. At step 420, the current geographical location is compared to values in a lookup table comprising various geographical locations associated with the default AC power supply. If the current geographical location is in the lookup table and the indicator flag is set, then at step 430, nothing needs to be done further. If the current geographical location is not on the lookup table and the indicator flag is set, then at step 440, a signal is sent to the camera system to change the exposure time to a different exposure time. If the current geographical location is not on the lookup table and the indicator flag is not set, then the program flow ends at step 430.

The values stored within the various lookup tables described above may be preprogrammed or may be provisioned to the wireless communication device. The process of provisioning the device may be accomplished through any technique that is currently known in the art. One example of a provisioning mechanism is the Binary Run-time Environment for Wireless (BREW) for CDMA-based devices, which is a secure platform for over-the-air distribution of applications to wireless communication devices.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method for correcting flickering caused by fluorescent lighting, comprising:
using a wireless signal to determine a current geographical location of a camera system;
using the current geographical location to determine a local alternating current (AC) operating frequency; and
changing the exposure time of the camera system if the local AC operating frequency is different from a previous AC operating frequency.

2. The method of claim 1, wherein the wireless signal is an Extended System Parameters Message associated with a Code Division Multiple Access (CDMA) network.

3. The method of claim 1, wherein the wireless signal is a Global Positioning System (GPS) signal.

4. The method of claim 1, wherein the wireless signal carries longitude and latitude information.

5. The method of claim 1, wherein the wireless signal is base station identifier.

6. Apparatus for correcting flickering caused by fluorescent lighting, comprising:
means for using a wireless signal to determine a current geographical location of a camera system;
means for using the current geographical location to determine a local AC operating frequency; and
means for changing the exposure time of the camera system if the local AC operating frequency is different from a previous AC operating frequency.

7. Apparatus for correcting flickering caused by fluorescent lighting, comprising:
a camera system; and
a wireless communication device communicatively coupled to the camera system, wherein the wireless communication device is configured to receive location information and to pass said location information to the camera system, whereupon the camera system uses said location information to determine a local alternating current (AC) operating frequency and to change the exposure time of the camera system if the local AC operating frequency is different from a previous AC operating frequency.

8. A method for correcting flickering caused by fluorescent lighting, comprising:
using a wireless signal to determine a current geographical location of a camera system;
comparing the current geographical location to a plurality of location entries in a lookup table, wherein the plurality of location entries share a common AC operating frequency; and
changing the exposure time of the camera system if the current geographical location does not match any of the plurality of location entries and if the present exposure time corresponds to the common AC operating frequency.

9. Apparatus for correcting flickering caused by fluorescent lighting, comprising:
means for using a wireless signal to determine a current geographical location of a camera system;
means for comparing the current geographical location to a plurality of location entries in a lookup table, wherein the plurality of location entries share a common AC operating frequency; and
means for changing the exposure time of the camera system if the current geographical location does not match any of the plurality of location entries and if the present exposure time corresponds to the common AC operating frequency.
